(19) United States
(12) Patent Application Publication
(10) Pub. No.: US 2008/0306194 A1
(43) Pub. Date: Dec. 11, 2008

(54) Hot-Melt Adhesive Compositions Based on Olefin Co-Polymers

(75) Inventors: Lixin Sun, Odessa, TX (US); Enrico L. Buenacosa, Odessa, TX (US); Jim Haselman, The Woodlands, TX (US)

Correspondence Address: Huntsman Corporation;Legal Department, 10003 woodloch Forest Drive, The Woodlands, TX, 77380, US

(73) Assignee: Huntsman Polymers Corporation, The Woodlands, TX (US)

(21) Appl. No.: 11/596,328

(22) PCT Filed: May 9, 2005
(86) PCT No.: PCT/US05/16250

§ 371 Date: Aug. 25, 2008

Related U.S. Application Data
(60) Provisional application No. 60/570,048, filed on May 11, 2004.

(51) Int. Cl. C08L 93/04; C08L 23/12; C08L 51/06; A41D 1/00; C08K 5/13; C08L 23/14

(52) U.S. Cl. 524/274; 524/583; 524/570; 524/502; 524/504; 524/323; 2/69

(57) ABSTRACT

The present invention relates to a new type of polyolefin based hot-melt adhesive and methods for their production. More particularly, it relates to a new type of hot-melt adhesive comprising propylene co-polymers and possessing a favorable balance of cohesive strength, adhesion properties, and processibility, which render them especially well-suited for some hot-melt adhesive applications, for example, as elastic attachment adhesives.

### FIELD OF THE INVENTION

The present invention relates generally to polyolefin polymers and their end uses. More particularly, it relates to adhesives which contain polyolefins and methods for their production, wherein the adhesives are hot-melt adhesive comprising propylene co-polymers which possess a favorable balance of cohesive strength, adhesion properties, and processibility.

### BACKGROUND INFORMATION

Conventional hot-melt adhesives are typically formulated using several components, such as polymer (typically SIS, SBS or SEBS block co-polymers), resins, tackifiers, oils, waxes, and other additives, to achieve a desired balance of properties. Adhesives produced by formulation and blending of such a wide range of materials are usually relatively expensive. At present, adhesives for such applications as elastic attachment are exclusively made by formulation of expensive non-polyolefin components.

Polyolefin-based hot-melt adhesives have been developed and commercialized for a number of years. One example of commercial product is REXTAC™ resins supplied by Huntsman Polymers Corporation. The compositions, processes and methods to produce polyolefin based hot-melt adhesives have been disclosed in a number of patents, including U.S. Pat. Nos. 4,859,757 and 4,847,340. While these polyolefins are useful in a number of construction adhesive applications, they do not possess the balanced properties required for certain other end-use applications, such as attachment of elastics used in diapers and other disposable personal care products. The critical properties required for the application include acceptable adhesion to polyolefins, including polypropylene and polyethylene film, polypropylene non-woven, SPANDEX® elastics and other elastic materials used in non-woven articles, and good cohesive strength with attendant sufficient flexibility to withstand repeated deformations.

US 2002/0123726 discloses an adhesive composition comprising blend of an isotactic polypropylene and an atactic polypropylene. The composition was claimed to have certain improved performance properties in making elastic composite laminates. However, it is apparent to those skilled in the art that the usefulness of the said composition as elastic attachment adhesive would be very limited due to its inherent poor adhesion to SPANDEX® elastic strands which are usually made of polar polymers.

WO 97/39075 discloses an adhesive composition comprising blend of a polybutene, a polyolefin co-polymer, a tackifier resin, a plasticizer, a wax as viscosity reducer, and a stabilizer. Again, it is apparent to those skilled in the art that the usefulness of the said composition as elastic attachment adhesive would be very limited due to its inherent poor adhesion to SPANDEX® elastic strands.

### BRIEF DESCRIPTION OF THE DRAWINGS

In the annexed drawings:

FIG. 1 shows the relationship between the crystallinity of a finished polymer and the Al/cyclohexylmethyldimethoxysilane (CHMMS) ratio used in producing the polymer; and

FIG. 2 shows methods known in the art for applying a polymer according to the present invention to a substrate.

### SUMMARY OF THE INVENTION

The present invention provides a composition of matter useful as an adhesive, which comprises four components. The first component is a polypropylene component, which is present in any amount between about 30% to about 90% by weight, based on the total weight of the composition. The polypropylene component may comprise a polypropylene homopolymer, a polypropylene co-polymer, or any mixtures of any two or more polypropylene homopolymers or polypropylene co-polymers, or a mixture comprising a polypropylene homopolymer and a polypropylene copolymer. The second component is a tackifier resins component, present in any amount between about 10% to about 60% by weight, based on the total weight of the composition. The third component is a functionalized polymer component present in any amount between about 0% to about 40% by weight, based on the total weight of the composition. The fourth component is a stabilizer(s) component, present in any amount between about 0.01% to about 1% by weight, based on the total weight of said composition.

### DETAILED DESCRIPTION

The invention is directed to hot-melt adhesive compositions, which are useful for, inter alia, bonding non-woven elastic composites. Compositions of the invention are particularly well-suited for use employing application techniques where the adhesive is applied in such a manner that it forms “point bonding” between elastic strands and substrates. For example, an adhesive according to the invention can be applied in a swirl pattern onto the pre-stretched elastic strands, then laminated with substrates to form the elastic composites. The present invention provides a novel, economic path to produce polyolefin based hot-melt adhesives.

The hot-melt adhesive compositions of this disclosure comprise a propylene co-polymer, a tackifier resin, a functionalized polyolefin, and one or more polymer stabilizers. The compositions possess performance properties that make them particularly useful in elastic attachment applications for disposable, non-woven articles, such as diapers. The compositions of the invention also provide improvement in certain physical properties, such as heat stability, as compared to the conventional styrenic block co-polymer-based adhesives currently used in these applications.

It is believed that the critical properties required for elastic attachment adhesives include good adhesion (to polyethylene film, polypropylene non-woven articles, and elastic strands such as SPANDEX® elastic strands), good cohesive strength, and certain flexibility to deform. Currently, providing resins having such qualities requires formulations which include expensive non-polyolefin components, typically including styrenic block co-polymers such as SIS, SBS or SEBS, resins or tackifiers, oil or waxes, and other additives, to achieve the balanced properties.

According to our invention, we have created a polyolefin based composition which possesses the above-mentioned properties, which properties rendering the compositions of our invention useful for elastic attachment applications in non-woven articles. According to a preferred form of the invention, a composition provided hereby comprises: a) 30% to 90% by weight of a propylene co-polymer; b) 10% to 60% by weight of tackifier resins); c) 0% to 40% by weight of a functionalized polymer; and d) 0.01% to 1% by weight of stabilizer(s).

### The Propylene Co-polymer Component

The propylene co-polymer is a co-polymer of propylene with another alpha-olefin comonomer selected from C₂ or C₄-C₂₀ alkenes. The preferred comonomers are 1-butene, 1-hexene and 1-octene. The most preferred comonomer is 1-butene. The content of co-monomer in the propylene co-polymer is about 0% to 60% by weight, preferably 15% to 50% by weight, most preferably 25% to 45% by weight.

The propylene co-polymer should have a low degree of crystallinity as measured by Differential Scanning Calorimetry (DSC). The heat of fusion as measured by DSC according ASTM method D-3417 should be about 0 to 50 J/g, preferably 5 to 20 J/g.

The propylene co-polymer has a weight-average molecular weight, as measured by Gel Permeation Chromatography (GPC), of 10,000 to 1,000,000, preferably 30,000 to 100,000, most preferably 40,000 to 80,000. The propylene co-polymer should have melt viscosity, as measured by Brookfield Viscometer, of 1,000 to 1,000,000 cps at 375° F., preferably 2,000 to 8,000 cps at 375° F., most preferably 3,000 to 5,000 cps at 375° F.

The propylene co-polymer can be synthesized by Ziegler-Natta catalysts or metallocene catalysts. Ziegler-Natta catalysts are well-known to those skilled in the art and generally refer to a type of catalysts that comprise a mixture of a base metal alkyl of the groups I to III metals, and a transition metal salt of groups IV to VIII metals of the periodic table of the elements. A Ziegler-Natta catalyst is basically a complex derived from a halide of a transition metal, for example, titanium, chromium or vanadium with a metal alkyl that is typically an organoaluminum compound. Typical advanced Ziegler-Natta catalysts are usually comprised of a titanium halide supported on a magnesium compound. Metallocene catalysts are well-known to those skilled in the art to include in its structure at least one cyclopentadienyl ligand coordinated to a transition metal. For economic consideration, the preferred catalyst used to produce the propylene co-polymer of the present invention is a Ziegler-Natta catalyst.

The propylene co-polymer can be produced in conventional polyolefin manufacturing processes including gas phase, slurry, bulk and solution processes in either batch or continuous mode. These processes are widely used in polyolefin industry and well-known to those skilled in the art. The preferred process is a “liquid pool” bulk polymerization process in which the polymerization reaction is carried out in the medium of liquid propylene.

### The Tackifier Resin Component

According to a preferred embodiment, the invention provides a composition that includes one or more tackifier resins. The tackifier resin must be compatible with the propylene co-polymer and can effectively promote the specific adhesion of the composition. While most commercial tackifier resins such as those derived from hydrocarbons, rosin, rosin esters, synthetic poly-terpenes and natural terpenes can be used, the preferred tackifiers are aliphatic hydrocarbon resins that are found to have the best compatibility with olefin polymers. The suitable amount of tackifying resin in the adhesive blend is about 5 to about 60% by weight, preferably about 15 to about 30% by weight.

### The Functionalized Polymer Component

According to a preferred embodiment, the invention provides a composition that includes a functionalized polymer in an adhesive composition. For purposes of this specification and the appended claims, the term “functionalized polymer” means a polymer containing polar groups in its structure. The functionalized polymer is used to promote the adhesion of the adhesive composition to the SPANDEX® elastic strands, which typically comprises a polyurethane polymer material. The functionalized polymer must be compatible with the other components in the adhesive composition. The preferred functionalized polymers are those having polyolefin backbone co-polymerized or grafted with polar monomers such as maleic anhydride. The most preferred functionalized polymers are low molecular weight polypropylenes grafted with maleic anhydride.

### The Stabilizer Component

A composition according to the invention also preferably includes one or more suitable stabilizer(s), present in the range of 0.01% to 1% by weight, based on the total weight of the polymer, to protect the polymers from degradation during processing and storage, and to maintain the integrity of adhesive during the lifetime of end use. Stabilizers useful herein are hindered phenols or combinations of hindered phenols and phosphates. These stabilizers are commonly used in polyolefins, and are well-known to those skilled in the art.

The adhesive composition, including all the components, is preferably mixed at an elevated temperature in the range of between about 300° F. to 400° F. by any suitable means of mechanical mixing such as agitation, circulating pump, and static mixer to form a homogeneous blend prior to application to a selected substrate for adhesive purposes. According to a preferred form of the invention, a final adhesive compositions has a melt viscosity measured at 375° C. of about 1,000 to 20,000 cps. Preferably the melt viscosity is between bout 2,000 to 8,000 cps. More preferably the melt viscosity is between about 2,000 and 4,000 cps.

According to a preferred form of the invention, the adhesive composition should have tensile strength of 50 to 400 psi preferably 100 to 300 psi, and tensile elongation of at least 50%, preferably at least 100%. (TBD)

### Test Methods Employed

Melt Viscosity (MV) was measured using Brookfield THERMOCEL® viscometer (RVTDV-I) in accordance with the ASTM D-3236.

Needle Penetration (NP), a measurement of hardness, was measured at room temperature using Universal Penetrometer Model BPT 735 following ASTM D-1321.

Ring and Ball Softening Point (RBSP), a measurement of heat resistance of adhesive material, was measured using Herzog MC 754 according to ASTM E-28.

Open Time (OT), which was the setting or elapsed time when a molten adhesive applied to a Kraft to Kraft paper substrate bond, was measured using a modified ASTM D4497.

Comonomer Content (% 1-Butene or % ethylene) in the polymer was determined using Nicolet Fourier Transform Infrared Spectrometer 5DXC. Specimen is prepared by a molten drawdown of a polymer on a Sodium Chloride crystal 30 mm in diameter.

The melting point and the heat of fusion were measured by Differential Scanning Calorimetry (DSC) on a Perkin Elmer PDSC-A-S instrument according to ASTM D-3417.

Tensile Properties were measured on Instron 5565 equipped with Class B-1 video extentiometer (ASTM D-638-98). Specimen are prepared by compression molded plaque, e.g., 8.0 inch×8.0 inch, die-cut to 0.5 inch×6.0 inch and conditioned for 40-hrs at 23° C.±2° C., 50%±5% humidity controlled room.

Creep Resistance is a test to measure the ability of an adhesive to withstand the stress under tension on the elastic strand or fibers on the two-laminated substrate. The lower creep value indicates a stronger holding capacity of the adhesive to hold the elastic strand or fibers between two substrates. Test specimen was prepared by applying an adhesive to the elastic strands, e.g., three (3) strands in parallel between two substrates. Test was conducted on the specimen under 300% tension from relax condition in a 38° C.±4° C. The calculation is:

% Creep=(Lᵢₙᵢₜᵢₐₗ−L_{Final})100/L_{Original@ 300%}

in which:

Lᵢₙᵢₜᵢₐₗ=Length of 300% Stretch Elastic Strand before Aging

L_{Final}=Length of Elastic Strand after Aging

L_{Original@ 300%}=Length of the 300% Stretch Specimen,
=(Lₒ/100+300)×100

### EXAMPLE 1

### Catalyst Preparation

A Ziegler-Natta catalyst may be prepared as follows: 30 g (0.315 mole) of MgCl₂ was co-comminuted with 5.22 g (0.0391 mole) AlCl₃ for 24 hours in a rotary ball mill under nitrogen atmosphere. Then 4.02 g (0.0212 mole) of TiCl₄ was added. Ball milling was continued for another 24 hours. About 30 g of yellow catalyst powder was collected. It was calculated that the titanium component was about 2.6% by weight, the aluminum component was about 2.7% by weight, the magnesium component was about 19.3% by weight, and the Mg:Al:Ti molar ratio was about 8:1:0.5.

### EXAMPLE 2-5

### Preparation of Propylene Co-Polymer

Polymerization was conducted in a one-liter autoclave reactor equipped with a mechanical stirrer. After the reactor was thoroughly purged with nitrogen to remove any catalyst poisons such as moisture and oxygen, prescribed amount of catalyst (table 1) was charged into the reactor as a 1 weight percent mixture in dry mineral oil, followed by addition of prescribed amounts of triethylaluminum (TEAL) as cocatalyst and optionally cyclohexylmethyldimethoxysilane (CHMMS) as selectivity control agent. Then hydrogen, as molecular weight regulator, and liquid propylene and 1-butene were charged into the reactor in subsequent order and the polymerization proceeded at 60° C. for 2 hours under sufficient agitation. At the end of the polymerization reaction, the unreacted monomers were vented off and the co-polymer product was recovered.

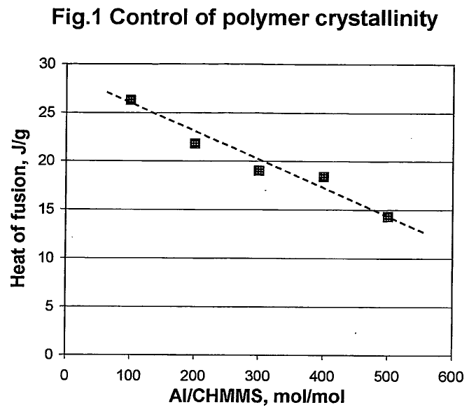

Examples of syntheses of several co-polymers and their properties are shown in Table 1 and 2. The crystallinity and percentage of comonomer in the polymer have major impact on the performance properties such as cohesive strength and adhesion property. FIG. 1 illustrates an effective way to control the crystallinity of polymer at given comonomer content by using different Al/CHMMS ratios.

TABLE 1
Synthesis of propylene co-polymers

| Example | 2 | 3 | 4 | 5 |
|---|---|---|---|---|
| Polymer ID | PB-1 | PB-2 | PB-3 | PB-4 |
| Catalyst, mg | 5 | 5 | 5 | 5 |
| TEA, mmole | 0.96 | 0.96 | 0.96 | 0.96 |
| CHMMS, mmole | 0.002 | 0 | 0.005 | 0.01 |
| Propylene, ml | 360 | 360 | 130 | 130 |
| 1-Butene, ml | 300 | 300 | 530 | 530 |
| H2, mole | 0.19 | 0.19 | 0.25 | 0.3 |
| Temp., ° C. | 60 | 60 | 60 | 60 |
| Time, hr | 2 | 2 | 2 | 2 |
| Yielg, g | 155 | 175 | 124 | 105 |

TABLE 2
Polymer properties

| Polymer ID | PB-1 | PB-2 | PB-3 | PB-4 |
|---|---|---|---|---|
| % butene | 33.5 | 39.2 | 69.4 | 63.0 |
| MV, cps | 6875 | 3460 | 6125 | 3410 |
| RBSP, F | 252 | 227 | 181 | 201 |
| NP, dmm | 11 | 30 | 15 | 6 |
| OT, sec | 100 | 330 | >23 min | 280 |
| T_{m,} ° C. | 94.9 | 88.3 | — | 60 |
| H_{f,} J/g | 14.3 | 3.2 | — | ~1 |

### EXAMPLES 6-9

### Adhesive Blends

The adhesive blends were prepared in a rotary low shear oil jacketed mixing equipment (Ross Mixer) under nitrogen atmosphere at the temperature between 150° C. to 190° C. for about 1 hour. (It is appreciated by those skilled in the art that the blending process can be done by any of the mixing techniques known in the art, provided that the method chosen provides homogeneous blends.)

VECTOR® 4211 resin is a linear SIS block co-polymer supplied by ExxonMobil Chemical Company. ESCOREZ® 5400 and 5415 resins are hydrogenated dicyclopentadiene tackifying resins produced by ExxonMobil. ENDEX® 160 resin is a alpha-methyl styrene tacking resin produced by Hercules Chemical Company. EPOLENE® E-43 wax is a maleated polypropylene wax supplied by Easman Chemical Company. EPOLENE® N-15 wax is a polypropylene wax supplied by Eastman Chemical Company. IRGANOX® 1010 anti-oxidant is a phenol antioxidant, and IRGAFOS® 168 anti-oxidant is a phosphite antioxidant.

Table 3 below shows several examples of adhesive blends. Comparative example A is a conventional adhesive composition disclosed in U.S. Pat. No. 6,531,544.

TABLE 3
Adhesive blend

| | Comparat. | Exam- | Exam- | Exam- | Exam- |
|---|---|---|---|---|---|
| Ingredient | example A | ple 6 | ple | ple 8 | ple 9 |
| VECTOR ® 4211 | 20 | — | — | — | — |
| PB-1 | — | 70 | — | — | — |
| PB-3 | — | — | 74.4 | — | — |
| PB-4 | — | — | — | 84.4 | 65 |
| ESCOREZ ® 5400 | 55.6 | 20 | 20 | — | — |
| ESCOREZ ® 5415 | — | — | — | 15 | 25 |
| ENDEZ ®160 | 9 | — | — | — | — |
| Naphthalenic oil | 15 | — | — | — | — |
| EPOLENE ® E-43 | — | 9.4 | 5 | — | — |
| EPOLENE ® N-15 | — | — | — | — | 9.4 |
| IRGANOX ® 1010 | 0.4 | 0.3 | 0.3 | 0.3 | 0.3 |
| IRGAFOS ® 168 | — | 0.3 | 0.3 | 0.3 | 0.3 |
| Brookfield | | | | | |
| viscosity, cps | | | | | |
| @300° F. | 4,450 | 9,200 | 11,288 | — | — |
| @325° F. | 2,123 | 4,900 | 7,263 | 5,970 | 4,660 |
| @350° F. | 1,115 | 3,310 | 4,900 | 4,170 | 2,700 |
| @375° F. | 753 | 2,245 | 3,280 | 2,980 | 1,880 |
| RBSP, ° F. | 195 | 293 | 264 | 193 | 292 |
| NP, dmm | 27 | 8 | 16 | 11 | 5 |
| OT, sec | 5 | 30 | 510 | 1380 | 193 |
| Tensile | 74 | 255 | 219 | 488 | 120 |
| strength, psi | | | | | |
| Tensile | 1560 | 285 | 618 | 392 | 340 |
| Elong., % | | | | | |

Laminations of specimens used for creep testing were made on a May Coatings Technology (CLS-300 Laminator) web drive unit utilizing a Nordson CF-200 with 0.018″ spiral spray head by laminating 3 elastic strands (LYCRA® 620 or 940 adhesives) stretched at 300% between a polypropylene spunbond NW fabric and polyethylene film.

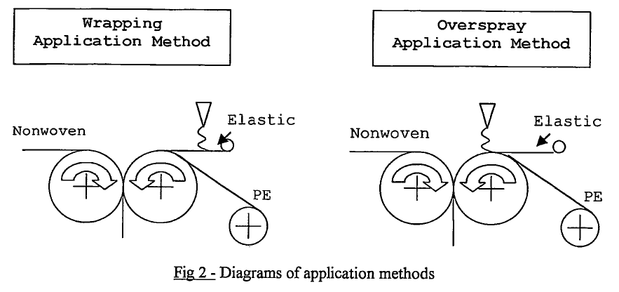

The adhesive was applied in a spiral spray pattern to the elastic strands utilizing 2 different application configurations. The first configuration is described in U.S. Pat. No. 4,842,666, and is referred to as the “Wrapping Application Method”. The second application method or “Overspray Application Method” is similar to the first, except the adhesive is applied to the elastic strands after the strands are laid down on top of the PE film. The methods are illustrated in FIG. 2.

Table 4 shows the results of creep test on the laminates prepared using several adhesive blends. Example 6 represents the preferred embodiment of the present invention and shows excellent creep resistance. Examples 7-9 are not presently viewed as performing particularly well, and are included herein to illustrate the effect of base polymer as well as the blend formula on the performance.

TABLE 4
Creep test on the laminates

| Adhesive | Compara | Compara | | | | |
|---|---|---|---|---|---|---|
| blend | Example A | Example A | Example 6 | Example 7 | Example 8 | Example 9 |
| LYCRA ® dTex | 940 | 620 | 620 | 620 | 940 | 940 |

% Creep at coat weight of 31 gsm, Overspray Method

| | | | | | | |
|---|---|---|---|---|---|---|
| 1 hour | 15 | 11 | 8 | 61 | 63 | 64 |
| 2 hour | 19 | 12 | 10 | 69 | 70 | 72 |

% Creep at coat weight of 23 gsm, Wrapping Method

| | | | | | | |
|---|---|---|---|---|---|---|
| 1 hour | 16 | 7 | 5 | 31 | 71 | 32 |
| 2 hour | 20 | 11 | 6 | 39 | 75 | 40 |

% Creep at coat weight of 31 gsm Wrapping Method

| | | | | | | |
|---|---|---|---|---|---|---|
| 1 hour | 11 | 7 | 7 | 37 | 84 | 40 |
| 2 hour | 14 | 9 | 8 | 44 | 88 | 45 |

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. The present disclosure includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the foregoing and other contents of this specification.

What is claimed is:

1) A composition of matter useful as an adhesive, which comprises:
a) about 30% to about 90% by weight, based on the total weight of said composition, of a polypropylene component selected from the group consisting of: polypropylene homopolymers, polypropylene co-polymers, and any mixtures of the foregoing;
b) about 10% to about 60% by weight, based on the total weight of said composition, of a tackifier resins component;
c) about 0% to about 40% by weight, based on the total weight of said composition, of a functionalized polymer component; and
d) about 0.01% to about 1% by weight, based on the total weight of said composition, of a stabilizer(s) component.

2) A composition according to claim 1 wherein the polypropylene component is a co-polymer of propylene and at least one other C₂-C₁₀ olefin monomer, wherein the co-monomer content in said propylene co-polymer is any amount between about 0.5% and about 60% by weight, based on the total weight of the co-polymer.

3) A composition according to claim 1 wherein said co-polymer has a degree of crystallinity as measured by method ASTM D-3417 of between about 0.2 and about 35 Joules per gram.

4) A composition according to claim 1 wherein said co-polymer has a weight-average molecular weight of between about 10,000 and about 1,000,000.

5) A composition according to claim 1 wherein said co-polymer has a melt viscosity in the range of between about 500 cps to about 1,000,000 cps @ 375° F.

6) A composition according to claim 1 wherein said tackifier resins component comprises one or more resins derived from a material selected from the group consisting of: hydrocarbons, rosin, rosin esters, synthetic poly-terpenes and natural terpenes.

7) A composition according to claim 1 wherein said tackifier resins component is present in any amount between about 10% to about 60% by weight based on the total weight of said composition.

8) A composition according to claim 1 wherein said functionalized polymer comprises a maleic acid anhydride graft co-polymer of polypropylene.

9) A composition according to claim 1 wherein said functionalized polymer comprises the reaction product of a maleic acid anhydride graft co-polymer of polypropylene with a material having an active hydrogen atom.

10) A composition according to claim 9 wherein said material having an active hydrogen atom is selected from the group consisting of: amines, polyalkylene amines, and polyoxyalkylene amines.

11) A composition according to claim 1 wherein said stabilizer component comprises one or more materials selected from the group consisting of phenols, hindered phenols, and phosphates.

12) A composition according to claim 1 wherein said composition has a melt viscosity of between about 500 cps and about 80,000 cps @ 375° C.

13) A composition according to claim 1 wherein said composition has a melt viscosity of between about 1500 cps and about 10,000 cps @ 375° C.

14) A composition according to claim 1 wherein said composition has a tensile strength of between about 50 and about 400 psi.

15) A composition according to claim 1 wherein said composition has a tensile elongation of at least 50%.

16) A composition according to claim 1 wherein said composition has a tensile elongation of at least 75%.

17) A composition according to claim 2 wherein said other olefin monomer is selected from the group consisting of: 1-butene and 1-octene.

18) A garment which is suitable to be worn by a person which comprises an adhesive according to claim 1.

19) A garment according to claim 18 wherein said garment comprises a strand of elastic material attached to a non-woven polyolefin-containing fabric.

20) A laminated structure which comprises an adhesive according to claim 1.
